(19) United States
(12) Patent Application Publication
(10) Pub. No.: US 2011/0117247 A1
(43) Pub. Date: May 19, 2011

(54) AGGREGATE COMPOSITIONS AND METHODS FOR POWDERED PRODUCTS

(75) Inventors: John B. Russell, Trumbull, CT (US); Thomas M. Plonski, Westfield, NJ (US); Sari Wacks, White Plains, NY (US)

(73) Assignee: KRAFT FOODS GLOBAL BRANDS LLC, Northfield, IL (US)

(21) Appl. No.: 12/621,931

(22) Filed: Nov. 19, 2009

(51) Int. Cl. A23P 1/02; A23L 1/302; A23L 1/304; A23L 1/236

(52) U.S. Cl. 426/72; 426/96; 426/97; 426/285

(57) ABSTRACT

Composition and methods including powder aggregates formed from tacking fine composition particles to agglomerates. The compositions provide powder aggregates where component segregation and dusting is reduced, and composition flow is improved. Embodiments can include a powder composition having an agglomeration greater than about 100 microns in diameter coated with a tacking agent; and a fine particle less than about 100 microns tacked to the agglomeration by the tacking agent. The agglomeration can be maltodextrin, flavorings, tea solids, and juice solids. The fine particles can be APM, Ace-k, sucralose, vitamins and minerals. The tacking agent can be acetylated monoglyceride, propylene glycol or a caprylic/capric triglyceride. Methods can include adding the agglomerate to a mixer; pouring the tacking agent directly over the agglomerate; mixing for approximately 1-4 minutes; adding the fine particle pre-blend component; and mixing the agglomerate component, tacking agent, and fine particle pre-blend component for approximately 1-4 minutes.

### FIELD

The present products and methods generally relate to powder compositions having aggregate components and specifically to compositions and methods of forming aggregate components by tacking fine particles to agglomerations, which result in improved product flow and reduced dusting and segregation.

### BACKGROUND

Agglomerations (or agglomerates) are known in the art as free-flowing reduced dust powders formed from clusters of substances such as maltodextrin, flavorings, tea solids, juice solids, milk solids and wheat flour. Agglomerates can be produced by moistening a powder with droplets of water and then re-drying in a stream of air. For example, maltodextrin is a spray-dried starch (a polysaccharide) that is used as a food additive or food flavor carrier and can be either moderately sweet or almost flavorless. Agglomerates are generally irregularly shaped, flow easily and can readily be wetted. As a result of these properties, agglomerates are popular in the powder food arts and particularly for powdered beverages.

Tacking agents are also known in the art to form an adhesive connection between particles of sufficient or varying strength to hold an aggregate together.

While there have been significant advances in the art, further advances are possible and desired. For example, powdered food compositions frequently have multiple components of various shapes and sizes. Such compositions can have the relatively large agglomerated components as well as other smaller/finer components such as sweeteners, vitamins and minerals. Small particles often segregate out of the powder compositions during processing, have poor flow characteristics and cause dusting. An advance in the art would be to tack the smaller particles of a powdered composition to an agglomerate component. This could reduce segregation of the composition components, improve flow characteristics, and reduce dusting. This would not only improve the manufacturing process of these powder compositions, but also provide a more consistent product for the consumers.

### SUMMARY

Accordingly, there is provided herein embodiments and methods of producing compositions including aggregates formed from tacking fine particles to agglomerates. The resultant compositions provide improved product quality and manufacturability since component segregation is reduced, dusting is reduced and composition flow is improved.

One embodiment provides a powder composition having an agglomeration component of greater than about 100 microns in diameter coated with a tacking agent; and a fine particle component of less than about 100 microns in diameter tacked to the agglomeration component by the tacking agent. The agglomeration can be food grade maltodextrin, flavorings, tea solids, juice solids, milk solids, wheat flour, or combinations thereof. The fine particle component can be a non-nutrient sweetener (such as aspartame, acesulfame potassium, sucralose, stevia, monatin, lo han guo, mogrosides, neotame, and the like), vitamins, minerals, colors, flavors, high value ingredients, high impact ingredients (used in small doses but have high impact), modulators such as sweetness enhancers, bitter blockers, flavor boosters, flavor enhancers, or combinations thereof. The tacking agent component can be polyhydric alcohols, vegetable oils, fluid monoglycerides, fluid diglycerides, caprylic/capric triglycerides, or combinations thereof.

In a preferred embodiment, the fine particle component is less than about 20 percent weight of the composition and the tacking agent component is about 0.01-2.0 percent weight of the final product.

Optional components can include the addition of acidulants, sugars, desiccants, or anti-caking components. The anti-caking component can be magnesium oxide, tricalcium phosphate, and the like.

Methods of making the aggregated powder composition can include the steps of blending the agglomerate component and the fine particle component with a tacking agent, then mixing the blend for approximately 1 to 25 minutes.

The blending sequence can include the steps of separately pre-blending the fine particle component; adding an agglomerate component to a mixer; pouring the tacking agent directly over the agglomerate; mixing the agglomerate component and tacking agent for approximately 1-4 minutes; adding the fine particle pre-blend component; and mixing the agglomerate component, tacking agent, and fine particle pre-blend component for approximately 1-4 minutes.

Additional steps can include adding flavor, color, accidulants, anti-caking components, and the like to the compositions. The tacking agent should aggregate the agglomerate component with the fine particle blend before any anti-caking component is added.

Other methods can include pre-blending the fine particle component and the agglomerate component, then pouring the tacking agent directly over the agglomerate/fine particle blend.

Other features will become more apparent to persons having ordinary skill in the art to which pertains from the following description and claims.

### DETAILED DESCRIPTION

The present products and methods generally relate to powder compositions having aggregate components and specifically to compositions and methods of forming aggregate components by tacking fine particles to agglomerations. The presented embodiments are suitable for food grade compositions, including powdered beverage compositions. The presented aggregate embodiments can have three main components including an agglomerate, a tacking agent, and a fine particle relative to the agglomerate. Generally, the methods below describe how to use the tacking agent for tacking the fine particles to agglomerations. The aggregate improves composition flow while minimizing segregation of the fine particle ingredients. The formed aggregate allows for improved plant packaging and filling speeds and mixology, due to reduced dusting and segregation, and can allow for better product solubility.

A core component of the presented aggregate is an agglomerate. Agglomerates can be formed by moistening a starting component powder with droplets of water and then re-drying in a stream of air. One characteristic of an agglomerate is its inherent irregular shape. In the food and beverage arts, agglomerates can include food grade maltodextrin, flavorings, tea solids, juice solids, milk solids, wheat flour or various combinations thereof. For the present embodiments, the agglomerate particles can also have a bulk density smaller than 0.5 gm/cc and an average particle size distribution (d50 as defined by Sympatec GmbH) greater than 100 microns in diameter (see generally: http://www.sympatec.com/Science/Characterisation/02_ParticelSizeDistribution.html). It is noted though that the dimension of the agglomerate is relative to the size of the fine material to be aggregated to it and thus can vary widely.

The fine particle components are components that are typically dusty and prone to segregation. Such components can include sweeteners, such as a non-nutrient sweetener (such as Aspartame (APM), acesulfame potassium (Ace-k), sucralose, stevia, monatin, lo han guo, mogrosides, neotame, and the like) vitamins, minerals, colors, flavors, high value and high impact ingredients (i.e., used in small doses but have high impact), modulators such as sweetness enhancers, bitter blockers, flavor boosters, flavor enhancers, and the like, and various combinations thereof. For the present embodiments, the fine particles can be ingredients that constitute less than about 20 percent weight of the overall composition and have a d50 of less than 100 microns in diameter. Again, it is noted that the dimension of the fine particle is relative to the size of the agglomerate to which it is aggregated and thus can vary widely.

Tacking agents can be any food grade material that is capable of forming an adhesive connection between particles with sufficient strength to hold an aggregate together. For the present embodiments, such tacking agents can include any food grade binding agent, such as polyhydric alcohols (such as propylene glycol), vegetable oils, fluid monoglycerides (such as a distilled acetylated monoglyceride sold under the trade name MYVACET, a product of Eastman Kodak, Inc), fluid diglycerides, caprylic/capric triglycerides (such as one sold under the trade name NEOBEE M-5 by Stepan Company Corporation of Delaware), and the like, and various combinations thereof.

As presented, the agglomerate provides an effective vehicle on which to attach fine materials compared to, for example, crystalline shaped particles such as sugar and citric acid. Sugar and citric acid are also components that are popular in the powdered beverage arts. In one of the present embodiments, the tacking agent is extremely effective with the irregularly shaped particle of an agglomerated maltodextrin. The irregular shape allows more areas for fine particles to be trapped to the surface compared to a smooth surface of a crystal. Not only does this reduce segregation of the agglomerate and fine particles, but the resultant aggregate has improved flowability.

Turning now to the table, there are shown exemplary embodiments of various aggregate compositions having a tacking agent to bind fine particles to irregularly shaped agglomerates.

TABLE

| | RANGE | | Example |
|---|---|---|---|
| INGREDIENT* | Low % wt | High % wt | % Weight |
| Sodium Citrate | 0 | 20.0 | |
| Tartaric Acid | 0 | 40.0 | |
| Granulated Salt | 0 | 8.0 | |
| Potassium Citrate, Monohydrate | 0 | 20.0 | |
| Acetylated Monoglyceride | 0.01 | 2.0 | 0.15 |
| Citric Acid | 18 | 80.0 | 42.00 |
| Malic Acid | 0 | 80.0 | |
| Acesulfame Potassium (Ace-K) | 0 | 2.0 | 1.30 |
| Maltodextrin, Agglomerated | 0 | 45.0 | 43.00 |
| Potassium Bicarbonate | 0 | 1.5 | |
| Aspartame (APM) | 0 | 20.0 | 5.30 |
| Sodium Bicarbonate | 0 | 2.5 | |
| Calcium Carbonate | 0 | 2.5 | |
| Silicon Dioxide | 0 | 1.0 | |
| Tricalcium Phosphate | 0 | 6.0 | 1.70 |
| Magnesium Oxide (MgO) | 0 | 3.5 | |
| Flavor | 0.5 | 27 | 0.55 |
| Tea Solids | 0 | 50 | |
| Monocalcium Phosphate | 0 | 40 | |
| Tricalcium Citrate Tetrahydrate, | 0 | 30 | |
| Vitamin Premix | 0 | 10 | |
| Vitamin C, Ascorbic Acid | 0 | 10 | |
| Beta Carotene | 0 | 1 | |
| Lutein | 0 | 6 | |
| Dry Vitamin E, Acetate, | 0 | 0.4 | |
| Gum, Xanthan, | 0 | 1 | |
| Sodium Carboxymethylcellulose | 0 | 1 | |
| Arabic Gum | 0 | 2 | |
| Juice Solids | 0 | 10 | 2.20 |
| Whey Protein Isolate | 0 | 35 | |
| Inulin Powder | 0 | 65 | |
| Dry Color | 0 | 4 | 3.80 |
| Sugar | 0 | 95 | |
| Total | | | 100.00 |

*Formulation weight in grams per 500 mls water: range of 1.9 to 16.3

The improved affect of aggregating these components can be studied by measuring both increased particle size distribution and Coefficient of Segregation (CoS) (as measured by the Fluidized Segregation Test developed by Jencke and Johanssen, Incorporated). For the Example illustrated in the Table, particle size distribution increased by 5 percent. The Coefficient of Segregation (CoS) was reduced by 25 percent. For these studies, the tracer for the fine particle component was APM.

The Example aggregate described above is a powdered drink composition. The un-tacked control had a d10 (as measured by Sympatec) of 25.5 microns, d50 of 106.9 microns and a CoS of 1.24 for APM. When the tacking agent was blended with the maltodextrin, and then blended with the fine particle ingredients and then ultimately blended with the remaining ingredients, the particle size distribution changed with a d10 of 38.4 microns (a 50% increase), d50 of 162.5 microns (a 52% increase) and the CoS went down to 0.2 for APM (an 84% reduction in segregation).

An example of a second embodiment of an aggregate with a tacked agglomerate process could be another powdered drink composition where the untacked control had a particle size distribution with a d10 of 15.08 microns, d50 of 234.05 microns and a CoS of 1.23. When the tacking agent is blended to maltodextrin, and then blended with the fine particle ingredients, and then ultimately blended with the remaining ingredients, the d10 increases to 18.47 microns (a 22% increase), d50 of 239.61 microns (a 2.4% increase), and the CoS decreased to 0.40 (a 68% reduction). A 50% decrease can also be found in the Relative Standard Deviation (% RSD) of both an aspartame and potassium acesulfame component at the mixer when the tacking agent, specifically an acetylated monoglyceride, is added. Another embodiment found a 38% decrease in the % RSD of the aspartame and 43% RSD reduction of the potassium acesulfame.

A preferred process to form an embodiment of a present aggregate can use the tacking agent to plate (cover/coat) an agglomerated material in a mixer, such as a ribbon, v-blender, and the like to, in effect, create sticky “nooks and crannies” in which fine particles may adhere. Next, the fine particle ingredients can be provided, such as APM, Ace-K, sucralose, vitamins, flavors, or other components that are dusty and prone to segregation. By tacking the fine particles to the larger particles a free flowing and reduced dust with little to no segregation is produced having better quality and greater efficiency on packaging lines.

Exemplary embodiments can specifically be prepared as follows. An agglomerate (such as Maltodextrin) can be added to a mixer, such as a ribbon mixer. A tacking agent, such as acetylated monoglyderide (approximately 0.01-2.0, preferably 0.05-2.0, and most preferably 0.05-0.70 percent weight of final formula) can be poured directly over the maltodextrin and mixed for approximately 1-4 minutes (preferably about 2 minutes). A fine particle pre-blend (such as APM and vitamins) can next be added and mixed an additional approximately 1-4 minutes (preferably about 2 minutes). The remaining ingredients (flavor, color, and the like) can next be added and mixed an additional approximately 1-25 minutes (preferably about 12 minutes).

An alternate method of preparation can include adding all of the ingredients (except acetylated monoglyceride), and then mixing anywhere from 1-25 minutes and then adding the acetylated monoglyceride on top of the mixed product and mixing for another 1-10 minutes. This method can also yield an improved mix. Also, simultaneously combining all of the ingredients (including the acetylated monoglyceride) and mixing for 1-25 minutes, will yield an improved mix.

Application of the tacking agent, such as acetylated monoglyceride, can include spraying or pouring, or the addition of an acetylated monoglyceride premix (premixing acetylated monoglyceride with one of the components).

Optional ingredients, such as acidulants, desiccants and anti-caking agents, can then be added. For example, citric acid and MgO can be added to the tacked aggregate composition and mixed for about an additional 5-15 minutes (preferably about 9 minutes). Citric acid, including citric acid crystals, is a mild acid used as an acidulant in foods. An acidulant can be used to lower or balance the pH of a food or beverage product. MgO should be added last, as it acts as a desiccant and anti-caking agent and would absorb the tacking agent. If added too early in the process, it would reduce the ability of the “tacking agent” to hold on tightly to the finer particles.

While the products and methods have been described in conjunction with specific embodiments, it is evident that many alternatives, modifications, and variations will be apparent to those skilled in the art in light of the foregoing description.

We claim:

1. An aggregated powder composition, comprising:
an agglomeration component of greater than about 100 microns in diameter coated with a tacking agent; and
a fine particle component of less than about 100 microns in diameter tacked to the agglomeration component by the tacking agent.

2. The composition of claim 1, wherein the agglomeration is selected from the list consisting of food grade maltodextrin, flavorings, tea solids, juice solids, milk solids, wheat flour, and combinations thereof.

3. The composition of claim 1, wherein the fine particle component is selected from the list consisting of a non-nutrient sweetener, vitamins, minerals, colors, flavors, high value ingredients, high impact ingredients, and combinations thereof.

4. The composition of claim 3, wherein the non-nutrient sweetener is selected from the list consisting of aspartame, acesulfame potassium, sucralose, monatin, lo han guo, mogrosides, neotame, and combinations thereof.

5. The composition of claim 1, wherein the tacking agent component is selected from the list of polyhydric alcohols, vegetable oils, fluid monoglycerides, fluid diglycerides, caprylic/capric triglycerides, and combinations thereof.

6. The composition of claim 1, wherein the fine particle component is less than about 20 percent weight of the composition.

7. The composition of claim 1, wherein the tacking agent component is about 0.05-0.70 percent weight.

8. The composition of claim 1, further comprising an acidulant.

9. The composition of claim 1, further comprising an anti-caking component.

10. A method of making an aggregated powder composition having an agglomerate component tacked with a fine particle component, comprising the steps of:
blending the agglomerate component and the fine particle component with a tacking agent;
mixing the blend for approximately 1 to 25 minutes.

11. The method of claim 10, wherein the blending sequence comprises the steps of:
pre-blending the fine particle component;
adding the agglomerate component to a mixer;
pouring the tacking agent directly over the agglomerate;
mixing the agglomerate component and tacking agent for approximately 1-4 minutes;
adding the fine particle pre-blend component; and
mixing the agglomerate component, tacking agent, and fine particle pre-blend component for approximately 1-4 minutes.

12. The method of claim 10, further comprising the steps of:
adding ingredients selected from the list consisting of flavor and color; and
mixing the composition for approximately 1-4 minutes.

13. The method of claim 10, further comprising the steps of:
adding an acidulant; and
mixing the composition for approximately 5-15 minutes.

14. The method of claim 10, further comprising the steps of:
adding an anti-caking component after the tacking agent has aggregated the agglomerate component with the fine particle blend; and
mixing the composition for approximately 5-15 minutes.

15. The method of claim 10, wherein the blending sequence comprises the steps, in order, of:
pre-blending the fine particle component and the agglomerate component; and
pouring the tacking agent directly over the agglomerate/fine particle blend.
